(19) United States
(12) Patent Application Publication
(10) Pub. No.: US 2008/0156865 A1
(43) Pub. Date: Jul. 3, 2008

(54) Wireless (RFID) enabled check presentation device

(76) Inventor: Richard Leifer, Melville, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/646,740

(22) Filed: Dec. 28, 2006

(51) Int. Cl. G06Q 40/00; G06Q 90/00

(52) U.S. Cl. 235/379

(57) ABSTRACT

A check presentation device provides the customers in a hospitality setting, such as a restaurant, with added convenience of instant payment capability. The check presentation device includes a wireless payment receiver, such as, for example and RFID receiver. The check and check presentation device are given to customer seeking to pay and leave the establishment. The customer uses their RFID enabled payment card or device and can input gratuity and/or other information directly into the check presentation device. The check presentation device is in communication with a central clearing facility that confirms receipt of payment and provides confirmation of the same and receipts to the customer directly.

### BACKGROUND

1. Technical Field

The present principles relate generally to wireless payment terminals, and more specifically, to a device with an integrated wireless reader (e.g., RFID) for presenting and allowing payment of bills in a hospitality setting.

2. Description of Related Art

It is a widespread practice in the hospitality industry to provide guests with services, present the guest with a bill, retrieve payment from the guest, and manually handle rectifying payment.

Recently, it has become a practice of vendors to allow their users to link a credit card or banking account to a Radio Frequency Identification device to allow quick and easy payment for purchases. Generally, this RFID device is a keychain fob, and is used in place of a credit card to make small purchases without a signature.

U.S. Pat. No. 6,169,483 to Ghaffari, et al., (hereinafter Ghaffari) describes a system for allowing a consumer self-checkout of articles via RFID tags disposed upon articles to be purchased. There, the consumer passes the articles with RFID tags through an RFID reader, which reads the RFID tags, the reader locating the item in a database, and totaling the consumer's bill.

Ghaffari does not disclose a convenient method for electronically presenting a guest check and handling payment via an RFID payment device.

Accordingly, a need exists for a device which allows the payment of bills through a wireless (e.g., RFID) device in a hospitality environment.

### SUMMARY

The problems stated above, as well as other related problems of the prior art are solved by the present principles, an electronic guest check presentation device capable of handling payments via an RFID payment device.

According to an aspect of the present principles, there is provided an RFID enabled guest check presentation device. The check presentation device includes a case within which is disposed an RFID antenna, a processor, input buttons, and a display screen.

According to another aspect of the present principles, the check presentation device further includes a communication device capable of communicating wirelessly to a base station.

According to yet another aspect of the present principles, the check presentation device further includes a socket-type communication device capable of being plugged into a base station and communicating to the base station.

These and other aspects, features and advantages of the present principles will become apparent from the following detailed description of preferred embodiments, which is to be read in connection with the accompanying drawings.

### BRIEF DESCRIPTION OF THE DRAWINGS

In the drawings where like reference numerals depict similar elements throughout the views:

FIG. 1 is a block diagram illustrating the interconnectivity of the active devices comprising an exemplary embodiment of a guest check presentation device with RFID payment capabilities.

FIG. 2 is an isometric view of an interactive guest check presentation tray with RFID payment capabilities.

FIG. 3 is a isometric view of the top surface of the RFID check tray of FIG. 1 showing additional features;

FIG. 4 is an isometric view of a exemplary embodiment of a check presentation device with RFID payment capabilities in book form;

FIG. 5 is an isometric view of an exemplary embodiment of an completely electronic check presentation device with RFID payment capabilities;

FIG. 6 is a flow diagram illustrating the process of presenting and electronically handling payment of a guest check using RFID payment device in a hospitality environment;

FIG. 7 is a flow diagram illustrating the process of electronically presenting and handling payment of a guest check using RFID payment device in a hospitality environment;

### DETAILED DESCRIPTION

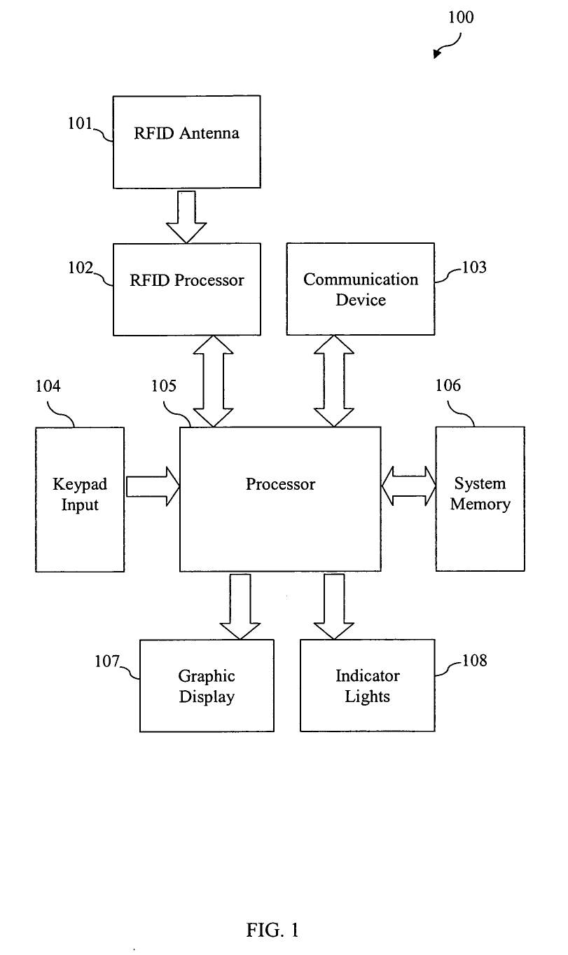

Referring now to the Figures, where like numbers indicate like features, the illustration of FIG. 1 depicts a block diagram illustrating an exemplary layout and interconnectivity of electronic devices comprising a guest check presentation device with RFID payment receiving capabilities 100 (hereinafter, RFID Device).

The RFID device 100 may include a wireless (e.g. RFID) antenna/receiver 101, and a dedicated RFID processor 102. In exemplary embodiments of the RFID device, the RFID antenna may be used to read information from an RFID payment token, such as, but not limited to, an RFID keychain fob, an RFID enabled credit card or RFID enabled hotel key. In particularly useful embodiments, the RFID antenna 101 may be integrated into the RFID processor.

The RFID processor 102 is also connected to a processor 105 in a manner that allows communication with the RFID processor 102. In one exemplary embodiment, the RFID processor may be connected to the processor 105 via a pin-to-pin multi-line data bus, a bi-directional bus, such as the Inter-Integrated Bus (12C), or via a serial connection. In another particularly useful embodiment, the RFID processor 102 may be integrated into the processor 105.

The processor 105 may also be connected to a communication device 103. In some exemplary embodiments, this communications device 103 may be a device capable of communicating with a base station wirelessly using RF transmissions. In one particularly useful embodiment, the communication device 103 may be an 802.11x receiver/transmitter, communicating using any supported RF transmission protocol. In another useful embodiment, the communication device 103 may be an infra-red transmitter/receiver capable of communicating with a base station in a wireless fashion using transmissions in the Infrared (IR) range.

Another exemplary embodiment of the communication device 103 may be where the communication device 103 is a contact socket connector which may be physically plugged into a docking station, where communication with a server and transmission of data may occur via the communications device 103. In one useful embodiment, the communications device 103 may be, but is not limited to, a serial socket such a USB plug, RS232 socket, or DB9 socket. In yet another particularly useful embodiment, the communications device 103 may be a multi-line bus socket similar to, but not limited to, a PCMCIA socket, 22-pin sync socket, IDE plug, or the like.

According to one implementation, the communication device 103 may be used to load information regarding a guest check onto the RFID device 100. In another exemplary embodiment, the communications device 103 may be used to transmit information regarding payment, such as verifying the account represented by an RFID payment device used to pay a guest check. The RFID payment device and be any known device, such as, for example, a credit card with RFID capability, a keychain or other compact RFID payment device, a cell phone having an RFID payment capability, a personal digital assistant (PDA) having RFID payment capability, etc.

For example, after a customer pays a guest check using the RFID payment device of their choice, the processor 105 may transmit the guest account information via a wireless communication device 103 to a base station or account server, where the account information is verified, and the account properly debited, after which the account server may transmit an acknowledgement back the communication device 103 residing within the RFID Device 100. Alternatively, the guest account information may be stored within system memory 106 until the RFID device 100 is returned to a dock or base station, where, upon the RFID device 100 being plugged into the dock, the communication device 103 then transmits the guest account information to a server where the appropriate guest account is debited. In another useful implementation, the communication device 103 may take the form of a physical socket which including one or more physical electrical connections used to charge batteries powering the RFID Device 100.

The processor 105 may also be connected in a bidirectional manner to some form of system memory 106. The system memory 106 may be any known or unforeseen class of digital memory such as EEPROM, EPROM, RAM, ROM, Flash Memory, removable digital storage such as a memory card or any combination thereof. The processor 105 may store and retrieve from the system memory 106 data such as, but not limited to, information regarding the guest check. Additionally, the system memory 106 may be used to store an operating system or computer code for execution by the processor 105 controlling the operation of the RFID device 100 and for controlling any specific applications that may be appropriate for the device and the establishment within which it is used (e.g., customer reward programs, customer reward redemption, etc.).

In some exemplary embodiments, the system memory 106 may be removably disposed within a socket to facilitate upgrades of memory. In another exemplary embodiment, the system memory 106 may be integrated into the processor 105, e.g. as with a microcontroller such as exhibited by the 80Cx51 microcontroller architecture.

One or more keypad inputs 104 may also be connected to the processor 105 to collect user input to be communicated to the processor 105. The keypad inputs 104 may include a numeric keypad for manually entering numeric data, buttons allowing a user to respond to prompts given on the graphic display 107, other buttons used to interact with the RFID device 100, or a combination thereof. In one exemplary embodiment, the keypad inputs 104 may be comprised of buttons representing individual digits for entering data, e.g. manually entering a numerical value representing a gratuity when a bill or guest check is presented to a guest in a hospitality setting such as a restaurant, hotel, or tavern. In another useful embodiment, the keypad inputs 104 may include one or more buttons to automatically add a fixed percentage of the presented bill as a gratuity before payment is tendered via an RFID payment token or device. In yet another exemplary embodiment, the keypad inputs 104 may also be comprised of one or more buttons for interacting with the RFID device 100. For example, a guest presented with a bill or check in a hospitality environment may be given the opportunity to press a Keypad Input 104 button indicating a standard gratuity percentage prior to payment via an RFID payment token. Additionally, a guest presented with a bill may be prompted to approve the amount to be charged by pressing a keypad Input 104 button indicating acceptance of the charge before using an RFID payment token to provide payment information.

Those of skill in the art will recognize that keypad 104 can be in the form of buttons (as shown), or could be integrated into the graphic display 107 as a touch sensitive display screen.

The processor 105 may also be connected to a Graphic Display 107, via which the processor 105 may display information regarding the current transaction to a guest or customer. The graphic display 107 may be any known or unforeseen device allowing the electronic display of text or pictorial information such as an LCD, active or passive matrix TFT screen, LED or OLED screen, etc. In an exemplary implementation, after the RFID device 100 is loaded with information regarding the guest check and presented to the guest, the graphic display 107 may show the total of the guest check, and prompt the user to enter a gratuity using the keypad input 104, or prompt the guest to make payment bringing the RFID payment device within range of the RFID antenna 101 disposed within the RFID device 100.

The RFID device 108 may also include one or more indicator lights 108 connected to the processor 105, and which may be used to signal the status of the RFID device 100. In one exemplary embodiment, the RFID device may include three indicator lights which may be of different color, wherein one indicator light 108 may be used to indicate that RFID device is ready for payment, one indicator light may indicated that the RFID device has received payment or that the RFID payment device was properly read and recognized by the RFID antenna 101 and RFID processor 102, and one indicator light 108 used to indicate that the payment approved and that the transaction is complete. In another exemplary embodiment, one of the Indicator Lights 108 may be used to indicate the charge status of batteries powering the RFID device 100.

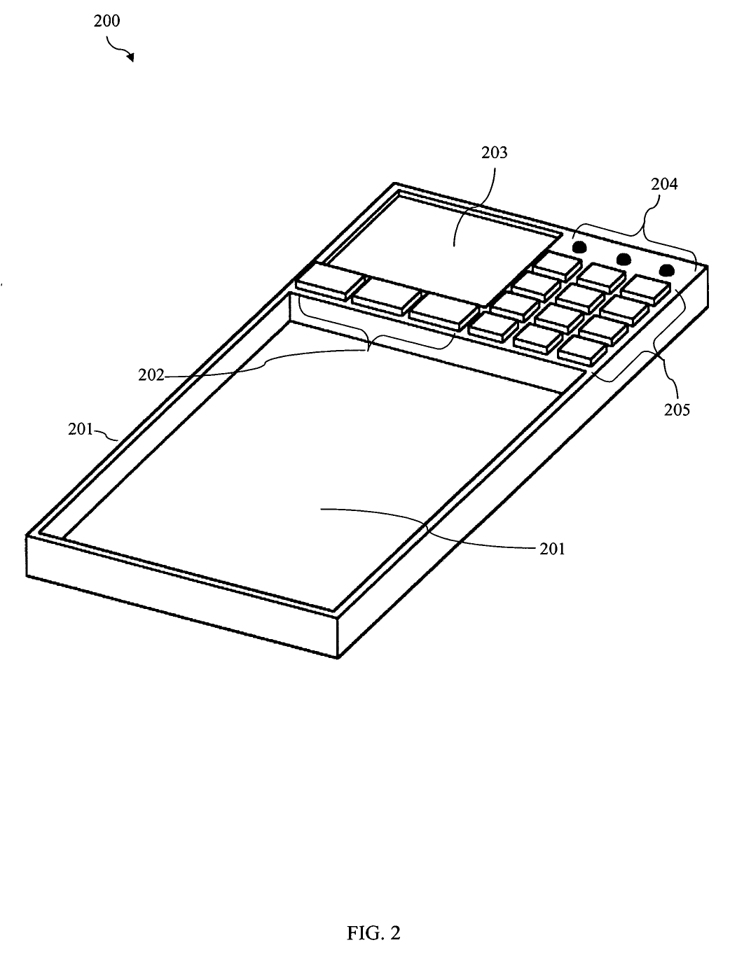

The illustration of FIG. 2 depicts an isometric view of a guest check presentation device with RFID payment capabilities (hereinafter, the RFID Device).

The RFID device 200 includes an enclosure, or housing 201, with a display screen 203 for displaying data to a user. The housing 201 may be made of any suitably rigid material (e.g. plastic, metal, etc.). In one exemplary implementation, the housing 201 may be used to house electronic components, such as those shown if FIG. 1, which may be needed to handle display, reading the RFID payment tokens, and communication. In another implementation, the housing 201 of the RFID device may include a recessed area 206 for disposition of a paper receipt for presentation to a guest.

The display screen 203 may be of any type suitable for displaying text, graphics, or a combination thereof, to a guest, as exemplified in FIG. 1. The display screen 203 may be used to show the total amount for a guest check, or provide instructions for use of the RFID device to the user. In another useful embodiment, the display screen 203 may be used to display responses to prompts on the display screen, which responses may be selected using keypad inputs of the keypad 204.

Response buttons 202 may be disposed adjacent to the display screen. In one preferred implementation, one or more response buttons 202 may each be labeled with a percentage for adding a tip or gratuity to the total check amount. In another useful implementation, the display screen 203 may show responses to a question or prompt shown on the display screen 203, with the response buttons 202 allowing a user to select a response button corresponding to one of the provided responses. For example, a guest may be presented with an RFID device 200 where the information regarding the guest's bill has been loaded. In this example, the device 200 may display possible responses on the display screen 203 directly above each response button 202, with a different possible response being associated with each response button 202. The RFID device 200 may display the total of the check, and the prompt the user to input a gratuity using the response buttons 202, if desired. In such a situation, prompts allowing a user to automatically add their choice of a predetermined or recommended gratuity amount may be provided, or alternatively, various options such as 10%, 15% or 20% gratuity may be displayed over the response buttons 202. After a gratuity, if any, is entered, the RFID may recalculate the guest check, including the gratuity, and prompt the guest to press a response button 202 to accept the totality of the charges.

Keypad input buttons 205 may also be disposed on the face of the RFID device 200. The keypad input buttons 205 may be used to manually enter numbers when more customized entry is required than provided by the response buttons 202. In an exemplary embodiment, the keypad input buttons 205 may be used to enter a gratuity or tip amount that does not correspond to the standard and automatically calculated amounts allowed entry by the response buttons 202. For example, a guest that feels he received excellent service may wish to give an extraordinary gratuity of 30%, and would be able to key that amount in via the keypad input buttons 205. In another embodiment, the keypad input buttons 205 may be used to enter a total charge amount including gratuity for a guest that prefers to charge a rounded amount when gratuity is added to the check. For example, a guest presented with an RFID device with a bill of $42.37 may wish to add gratuity such that the total charge is $50.00 instead of automatically adding a percentage that result in a charge that does not total an easily accountable amount. As mentioned above, keypad input buttons 205 could alternatively be integrated into the display 203 as a touch sensitive display.

Indicator lights 204 may be disposed on the housing 201 of the RFID device 200. One or more of the indicator lights 204 may be used to display the status of the RFID 200 device to the guest, the server handling the transaction, or others. In an exemplary implementation, one indicator light 204 may be used to show that the RFID device is functioning properly, and is ready to receive payment. In this embodiment, a server may load information regarding the guest check into the RFID device, after which the indicator light 204 may illuminated indicating the RFID device is ready to be presented to the guest. In another exemplary embodiment, one indicator light 204 may be used to show that payment has been made by the guest, and that the RFID device may be retrieved by the server. In yet another embodiment, one indicator light may be used to show that the RFID device 200 was unable to read the guest's RFID payment device, or that the guest payment was not accepted due to the guest account being invalid or having insufficient funds.

Additionally, in one useful embodiment, the indicator lights 204 may be disposed on the face of the RFID device 200 as exemplified in FIG. 2, or the indicator lights 204 may located elsewhere, such as the upper end face of the RFID device 200.

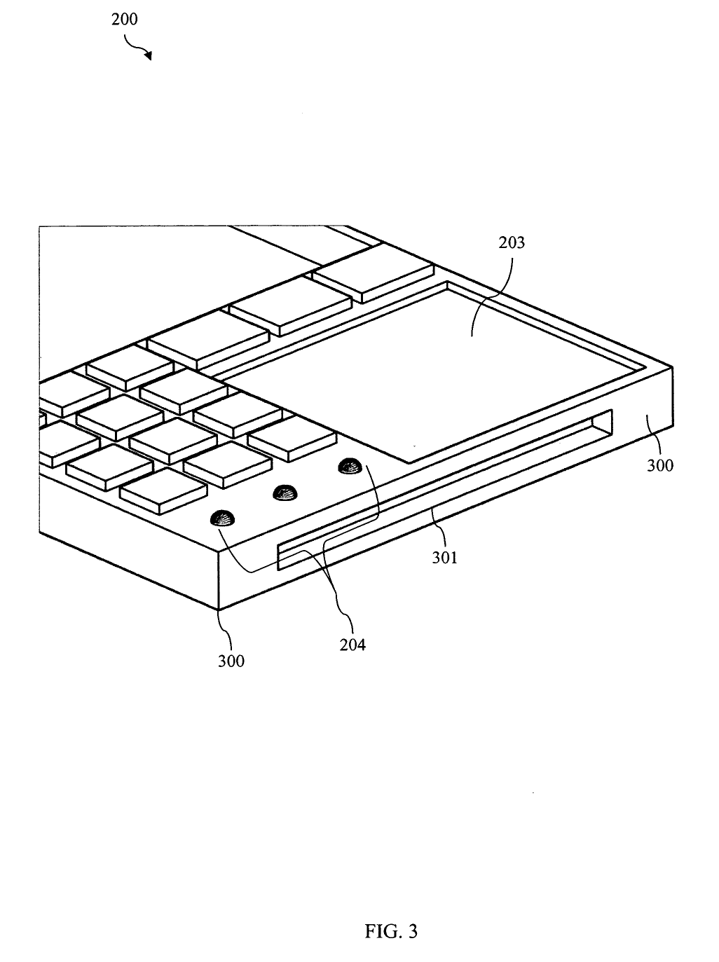

Referring now to FIG. 3, the upper face 300 of the RFID device as shown in FIG. 2 is displayed in isometric detail. In this Figure, the RFID device includes an opening 301 allowing access to a communications socket or device 103 disposed within the opening 301. In the embodiment exemplified in FIG. 3, socket and opening 301 may be disposed within the upper end surface or face of the RFID device 200. In other useful implementations, the socket and opening 301 may be disposed within the lower end or face, or any other portion of the RFID device 200 housing 201. The disposition of the socket and opening 301 may allow multiple RFID devices 200 to be plugged into a single base station parallel to one another, allowing for a compact storage arrangement.

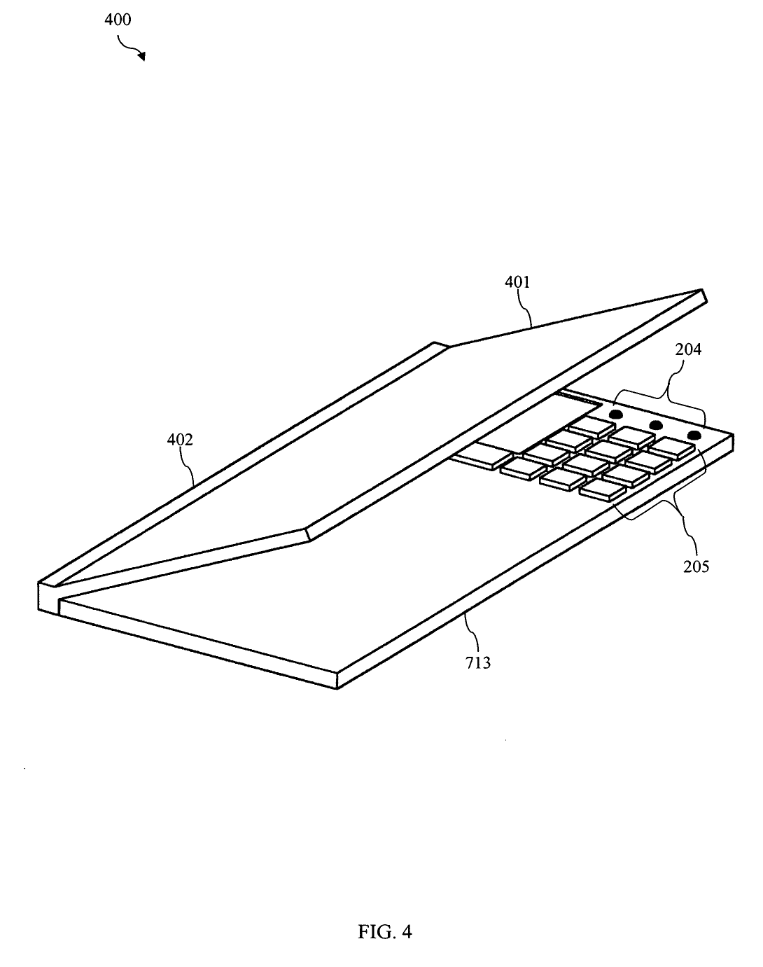

The illustration of FIG. 4 depicts an isometric view of an alternative exemplary embodiment 400 of the RFID Device 200 as shown in FIG. 2. In this embodiment, a cover 401 is hingedly attached to the housing 201 of the RFID device via a spine 402. The cover 401 may be opened and closed in order to insert a guest check, or to access the interactive features of the RFID device.

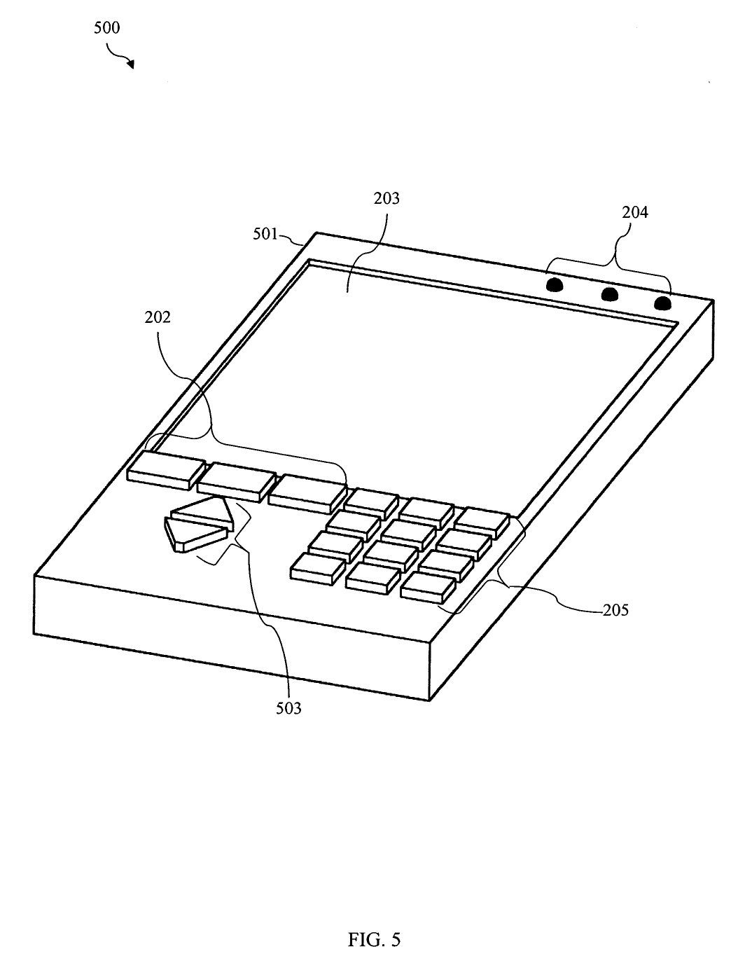

The illustration of FIG. 5 depicts an isometric view of another alternative implementation 500 of guest check presentation device with RFID payment capabilities.

In this implementation, response buttons 202, a display screen 203, indicator lights 204, and keypad input buttons 205 may be disposed within a housing or case 501. According to one particularly useful implementation, the display screen 203 may be of a size suitable for displaying multiple lines of a guest check. Additionally, navigation buttons 503 may be disposed within the case 501. In some embodiments, the navigation buttons may be used to scroll the text shown on the display screen 501.

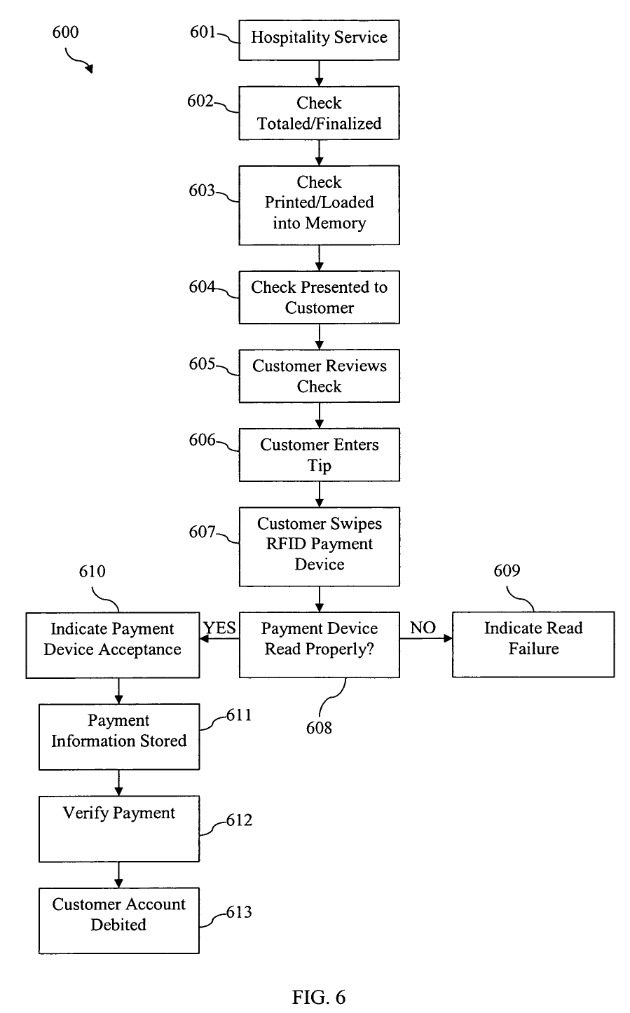

FIG. 6 is a flow diagram illustrating the process of presenting and electronically handling payment of a guest check using RFID payment device in a hospitality environment.

In this process 600, after hospitality service 601 such as a meal is completed, the guest check is totaled or finalized 602. The totaled guest check is then printed, if necessary, and loaded 603 into the RFID Device system memory 106. The RFID Device 100 with the guest check loaded into system memory 106 is then presented to the customer 604. The customer then has the opportunity to review the check 605, ensuring that the check conforms to their expectations. The customer may then be prompted by the RFID device 100 to enter a tip or gratuity 606 if the customer desires. After the customer enters a tip or gratuity 606, the customer then swipes an RFID payment device 607 by bringing the RFID payment device into such proximity to the RFID antenna 101 that the RFID antenna 101 and RFID processor 102 disposed within the RFID device 100 may read the RFID payment device. The RFID device 100 then determines whether the RFID payment device was read properly 608.

Where the RFID payment device was properly read, the RFID device 100 indicates RFID payment device acceptance 610, and stores payment information 611 in the RFID device 100 system memory 106. The payment information may next be verified 612, after which the customer account is debited 613.

Where the RFID device determines that the payment device was not properly read, the RFID device then indicates the RFID Device failed to read the payment device 609.

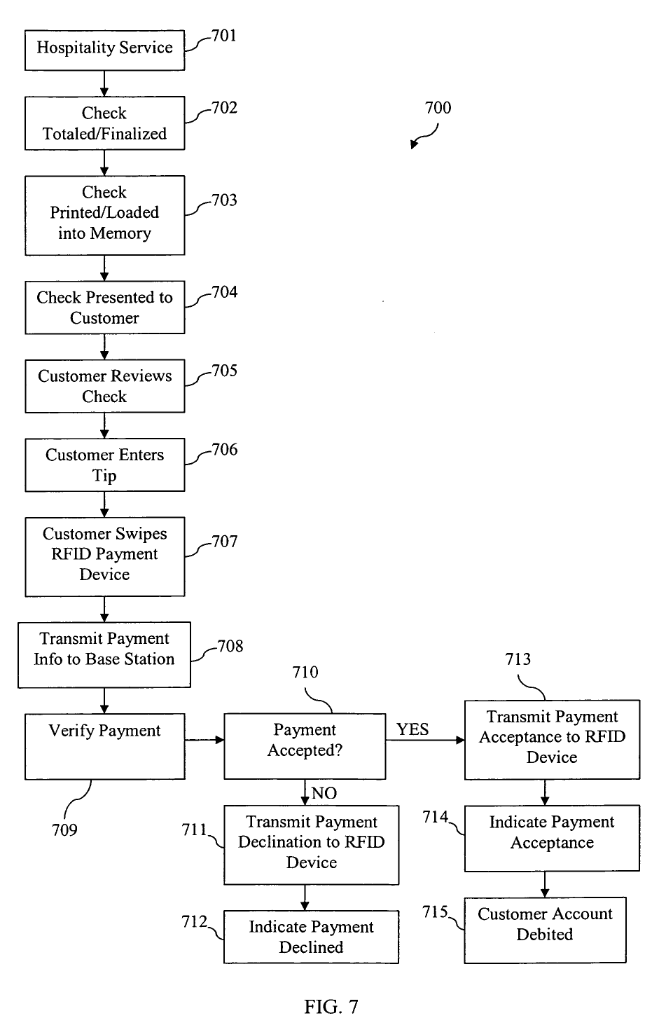

FIG. 7 is a flow diagram illustrating an alternative embodiment of a process for presenting and electronically handling payment of a guest check using RFID payment device in a hospitality environment.

In this exemplary embodiment 700, after hospitality service 701 is completed, the guest check is totaled or finalized 702. The guest check is then printed, if necessary, and loaded 703 into the RFID device 100 system memory 106. The RFID device loaded with the guest check is then presented to the customer 704. The customer then reviews the check 705, and enters a tip, if desired 706. The customer then swipes an RFID payment device 707 to make payment. The RFID payment device information is then wirelessly transmitted to a base station 708 via a communication device 103, where a payment is verified 709. The base station then determines whether payment was accepted 710.

The customer RFID device that is used for swiping may be any type of RFID payment device. Examples of such devices include, but are not limited to, RFID enabled credit cards; RFID enabled wireless telephones; RFID enabled personal digital assistants (PDAs), RFID Keychain type devices; RFID USB keys, and any other known, or not yet known device that contains and RFID type device or Radio tag that contains and/or stores customer payment information that can be interrogated and obtained during an RFID payment transaction.

When the payment via RFID payment device is accepted, acceptance of the payment is transmitted 713 wirelessly to the RFID device 100. The RFID device 100 then indicates payment acceptance 714, and the customer account is debited 715 accordingly.

Where the base station determines that the payment was not accepted, declination of the payment is transmitted 711 to the RFID device 100, which then indicated that the payment was declined 712.

Those of ordinary skill in the art will recognize that the examples given herein are for exemplary purposes and may be changed without departing from the spirit of the invention.

Although illustrative embodiments of the present principles have been described herein with reference to the accompanying drawings, it is to be understood that the present principles are not limited to those precise embodiments, and that various other alterations, modifications and improvements may be affected therein by one skilled in the art. Such alterations, modifications and improvements are intended to be within the scope and spirit of the present principles. Accordingly, the foregoing description is by way of example only and is not intended to be limiting. This present principles should be limited only by the claims and equivalents thereof.

What is claimed is:

1. A guest check presentation device comprising:
a housing;
a processor disposed within the housing;
a wireless receiver connected to the processor;
at least one input device connected to the processor; and
a graphic display connected to the processor.

2. The guest check presentation device of claim 1, the guest check presentation device further comprising at least one indicator light.

3. The guest check presentation device of claim 1, wherein the wireless receiver comprises an RFID receiver.

4. The guest check presentation device of claim 3, the guest check presentation device further comprising an RFID processor electrically connected to the processor and the RFID antenna.

5. The guest check presentation device of claim 1, the guest check presentation device further comprising a communication device electrically connected to the processor.

6. The guest check presentation device of claim 5, wherein the communication device is a wireless communication device.

7. The guest check presentation device of claim 5, wherein the communication device is a contact type socket.

8. The guest check presentation device of claim 1, wherein said at least one input device comprises a keypad.

9. The guest presentation device of claim 1, wherein said at least one input device comprises a touch screen display, wherein said graphic display and said touch screen display are integrated into one display unit.

10. The guest presentation device of claim 8, wherein the keypad input comprises numeric keys for entering monetary values relating to a service to be paid.

11. The guest presentation device of claim 1, the keypad input comprising at least one response button electrically connected to the processor.

13. The guest presentation device of claim 1, the device further comprising system memory, said memory capable of providing application specific and/or transaction specific information.

14. The guest presentation device of claim 1, further comprising a gratuity calculation mode of operation.

15. The guest presentation device of claim 14, wherein said gratuity calculation mode provides guest input of a gratuity amount.

16. The guest presentation device of claim 15, wherein said gratuity calculation mode further comprises providing recommended gratuity amounts to the guest.

17. A guest check presentation device, comprising:
a processor;
a wireless receiver connected to the processor;
a communication device connected to the processor; and
at least one indicator light connected to the processor.

18. The guest check presentation device of claim 17, wherein said wireless receiver comprises one selected from a group consisting of an RFID receiver, an RF receiver, a VHF receiver, a UHF receiver, and a Microwave receiver.

19. The guest check presentation device of claim 17, wherein the communication device is a wireless communication device.

20. The guest check presentation device of claim 17, the device further comprising at least one input device connected to the processor for enabling guest input.

21. The guest check presentation device of claim 20, wherein said at least one input device comprises a keypad.

22. The guest check presentation device of claim 20, wherein said at least one input device comprises a touch screen display.

23. The guest check presentation device of claim 20, further comprising a gratuity calculation mode of operation.

24. The guest check presentation device of claim 23, wherein said gratuity mode of operation provides the guest with the ability to input a gratuity amount.

25. The guest check presentation device of claim 23, wherein said gratuity calculation mode further comprises providing recommended gratuity amounts to the guest.

26. A method for electronically presenting and handling payment of a check for a guest, the method comprising:
totalling the check;
presenting the check to the guest in an RFID enabled check presentation device;
providing, by the guest, an RFID payment device; and
reading the RFID payment device by the RFID enabled check presentation device.

27. The method of claim 26, further comprising:
determining, at the RFID enabled check presentation device, whether the RFID payment device provided by the guest was read properly; and
indicating whether the RFID payment device was read properly.

28. The method of claim 26, further comprising:
storing payment information of the guest in a system memory when the RFID payment device was read properly;
verifying payment; and
debiting the guest account.

29. The method of claim 26, further comprising:
transmitting payment information from the RFID enabled check presentation device to a base station;
verifying payment at the base station;
determining whether payment was accepted at the base station;
transmitting payment acceptance/declination from the base station to the RFID enabled check presentation device;
indicating payment acceptance/declination at the check presentation device; and
debiting customer account through the base station when payment acceptance is indicated.

30. The method of claim 26, wherein said RFID payment device comprises one selected from a group consisting of RFID enabled credit cards, RFID enabled wireless telephones, RFID enabled personal digital assistants (PDAs), RFID Keychain type devices and RFID USB keys.

31. The method of claim 26, further comprising providing a gratuity calculation mode of operation to the user.

32. The method of claim 31, wherein said gratuity calculation mode of operation further comprises providing the guest with the ability to input a gratuity amount.

33. The method of claim 31, wherein said gratuity calculation mode further comprises providing recommended gratuity amounts to the guest.
